(19) United States
(12) Patent Application Publication
(10) Pub. No.: US 2004/0084808 A1
(43) Pub. Date: May 6, 2004

(54) Flow pin for injection molding

(76) Inventor: Ronald D. Clarke, Algonac, MI (US)

Correspondence Address: REISING, ETHINGTON, BARNES, KISSELLE, P.C., P O BOX 4390, TROY, MI, 48099-4390, US

(21) Appl. No.: 10/288,817

(22) Filed: Nov. 6, 2002

(51) Int. Cl. B29C 45/16; B29C 45/40

(52) U.S. Cl. 264/328.12; 425/130; 425/556

(57) ABSTRACT

A mold flow pin that is a cylindrical element and includes first and second ends. The first end is attached to an ejector plate of an injection mold. The second end of the cylindrical element is disposed near a gate opening of a mold cavity. The second end includes flow modifying geometry formed on the cylindrical element. The flow geometry is designed to increase a mass of plastic material near the gate opening. The geometry also reduces the injection pressure of the plastic material and increases a flow rate of plastic material into the mold cavity when compared with conventional injection molding gate orifices.

### FIELD OF THE INVENTION

The invention relates to injection mold flow pins, and more particularly to injection mold flow pins having geometry adapted to increase a mass of plastic material near a gate opening.

### BACKGROUND OF THE INVENTION

Generally, when injection molding plastic parts, gating is an important feature of the mold tooling. The criteria involved in determining aspects of the gating include flow rates for filling the mold cavity, repeating the molding operation, as well as cosmetic considerations of surfaces of the parts to be molded. When a plastic part having a cosmetic or “class A” surface is necessary, the flow of plastic material into the mold is limited in that the gate orifice generally has an area that is less than 50 percent of the thickness of the part to be molded. This limitation is primarily utilized to limit sink of the part in a region of the gate orifice.

Secondary trimming or finishing operations are often required for cosmetic plastic parts when they are ejected from the mold after a curing operation. It would, therefore, be desirable to design a gate flow pin that modifies the flow of plastic material near a gate orifice such that the flow area is greater than 50 percent of the part thickness while still maintaining the cosmetic surface of parts. It is also desirable to include a flow pin that has geometry that eliminates secondary trimming operations to remove plastic tabs that are formed after curing the part formed in a region of the gate orifice.

### SUMMARY OF THE INVENTION

In accordance with a preferred embodiment of the invention, a mold flow pin basically comprises a cylindrical element that includes first and second ends. The first end is attached to an ejector plate of the injection mold. The second end of the cylindrical element is disposed near a gate opening of a mold cavity. The second end includes flow modifying geometry formed on the cylindrical element. The flow geometry is designed to increase a mass of plastic material near the gate opening. The geometry also reduces the injection pressure of the plastic material and increases a flow rate of plastic material into the mold cavity when compared with conventional injection molding gate orifices.

There is also disclosed a method of forming a plastic part in an injection mold including the steps of: providing an injection mold tool that has a mold cavity shaped to form a part, providing a bore in the injection mold tool that extends from an ejection plate at a first end to a gate opening entering the cavity of the injection mold at the second end, disposing a flow pin within the bore, the flow pin comprising a cylindrical element that has the first end attached to the ejector plate of the mold and the second end disposed near a gate for introducing plastic material into the mold cavity. The second end of the cylindrical element includes flow modifying geometry. Plastic material is introduced into the mold cavity from the gate such that the plastic material flows over the geometry of the flow pin wherein a mass of plastic material is increased near the gate opening and wherein an injection pressure is reduced and a flow rate of plastic material into the mold cavity is increased compared to conventional injection molding flow rates.

### BRIEF DESCRIPTION OF THE DRAWINGS

FIG. 1 is an isometric view of a flow pin in accordance with the present invention detailing the flow modifying geometry formed thereon;

FIG. 2 is a side view detailing the intersection of the flow pin with a gate wherein a plastic tab is formed and forced away from the flow pin due to the geometry of the flow pin;

FIG. 3 is a side sectional view detailing the tooling of an injection mold including the flow pin attached to an ejector plate with a part being formed in a mold cavity;

FIG. 4 is an isometric view detailing alternative embodiments including an axial radius formed on the land portion of the flow pin;

FIG. 5 is an isometric view of a tool including two flow pins disposed 180 degrees apart;

FIG. 6 is an end view of the flow pin detailing the radius of the land portion.

### DETAILED DESCRIPTION OF THE PREFERRED EMBODIMENTS

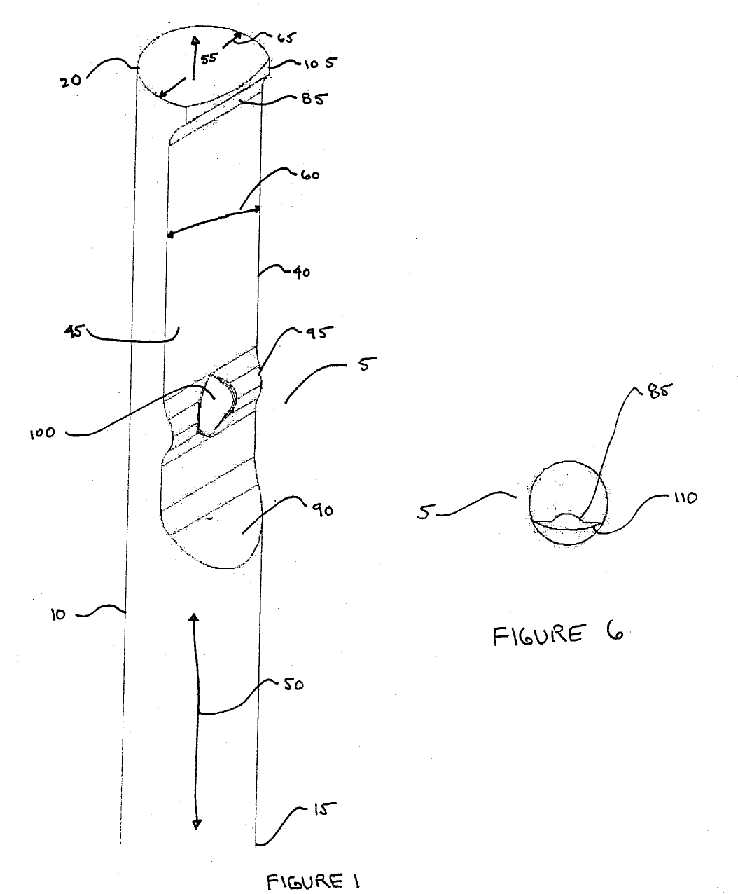

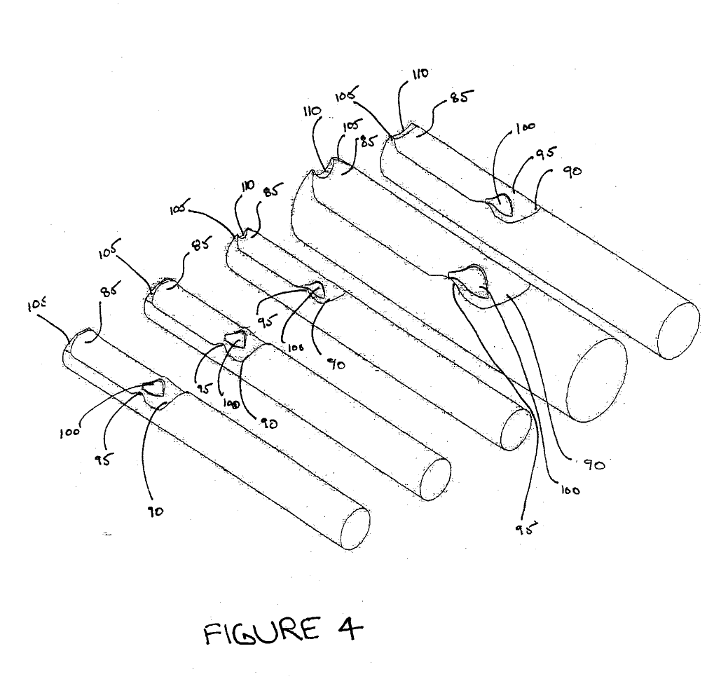

With reference to FIG. 1, there is shown a first embodiment of a flow pin 5 of the present invention. The flow pin 5 is a cylindrical element 10 that includes first 15 and second 20 ends. The first end 15 is attached to an ejector plate 25 of an injection mold 30, as will be discussed in more detail below with reference to FIG. 4. The second end 20 is disposed proximate a gate opening 30 of a mold cavity 35. The second end 20 includes flow modifying geometry 40 formed thereon. The flow modifying geometry 40 is adapted to increase a mass of plastic material near the gate opening 30. The increased mass of plastic material preferably forms a tab 115 which will be discussed in more detail below. The flow modifying geometry 40 reduces a pressure of the plastic material flowing into the mold as well as increases a flow rate of plastic material into the mold cavity by allowing an orifice area of greater than 50 percent of the part thickness without affecting the surface quality of a part to be formed in the mold.

The flow modifying geometry 40 generally comprises a planar area 45 having a length 50 along the centerline 55 of the cylindrical element 10. The planar area 45 also has a width 60 along a diameter 65 of the cylindrical element 10. The planar area 45 generally comprises a cutaway section 70 or an area removed from the cylindrical element 10. The planar area 45 is bounded on opposite ends 75, 80 of its length 50 by first 85 and second 90 radius portions. The planar area 45 also includes a raised ridge 95 formed across the width 60 of the planar area 45. In a preferred aspect, the raised ridge 95 includes a channel 100 extending through the raised ridge 95 in a direction of the length 50 of the planar area 45. As seen in FIG. 1, the channel 100 has an elliptical cross-section, although other cross-sectional shapes may be utilized without departing from the inventive aspect.

As can be seen in FIG. 1, the first radius portion 85 is proximate the second end 20 of the cylindrical element 10. The first radius 85 terminates in a land portion 105 that is minimized for enhancing the flow characteristics of plastic introduced into the mold cavity. The land portion 105 shown in FIGS. 1, 4 has a convex upper surface with a narrow thickness preferably in the range of from 10/1,000th to 20/1,000th of an inch, radial in design to increase area and flow of molten plastic material. A standard fixture for manufacturing and/or altering such radii maybe utilized by end users of the flow pin to form custom radii based on various molding requirements.

With respect to FIGS. 4 and 6, other land portion designs are shown including concave land surfaces, a land surface that has a variable curvature that increases from one side of the land portion 105 to the other side in a direction corresponding to the width 60 of the planar area 45, and land portions 105 including a radial flow channel 110 formed therein. The radial flow channel 110 can have various sizes and shapes as is shown in FIG. 4 such that specific flow characteristics dependant on a molding operation can be achieved. In the pictured preferred embodiments the flow channel is radial, it is to be understood that other geometries may be utilized for various applications without departing from the inventive aspect. Optionally, the flow pin 5 may include a machine portion forward of the land surface such that material may be removed such that a custom fit per a specific mold geometry can be achieved for a specific design.

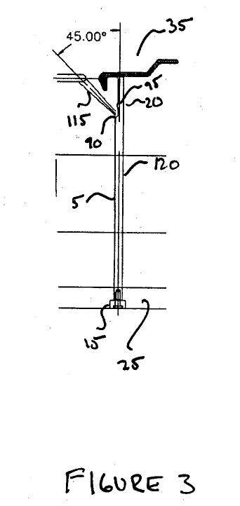

Referring to FIG. 3, the flow pin 5 of the present invention is shown in a side-sectional view of an injection mold that includes a bore 120 formed therein. The bore 120 terminates in a cavity 35 of the mold at a first end and an ejection plate 25 of the mold at the second end. A cylindrical element 10 is disposed in the bore 120 and includes a first end 15 attached to the ejector plate 25 of the mold and second end 20 disposed proximate the gate opening 30 of the mold cavity 35. The second end 20 includes the flow geometry 40 as discussed above. As can be seen in FIG. 3, a gate 115 intersects with the flow pin 5 in a region of the second radius portion 90 of the flow pin 5. Preferably, the gate 115 intersects the second radius 90 at an angle of from 20 to 50 degrees as measured along a centerline of the gate with respect to a centerline of the flow pin 5. Preferably, the gate 115 is maintained at an angle of approximately 45 degrees with respect to the second radius portion 90.

As plastic material is introduced from the gate 115, it contacts the second radius 90 and begins flowing in a direction towards the raised ridge 95 formed across the width 60 of the planar area 45. The plastic mold material enters the channel 100 extending through the raised ridge 95, and continues in a direction towards the first radius portion 85. The plastic fluid when intersecting the first radius portion 85 loses a portion of its kinetic energy due to its travel up the inclined radial curvature of the first radius portion 85; thereby, lowering a pressure of the traveling plastic material. In this manner, the pressure of the plastic entering the mold is reduced while still maintaining a high flow rate due to the area of the orifice provided by the flow pin 5.

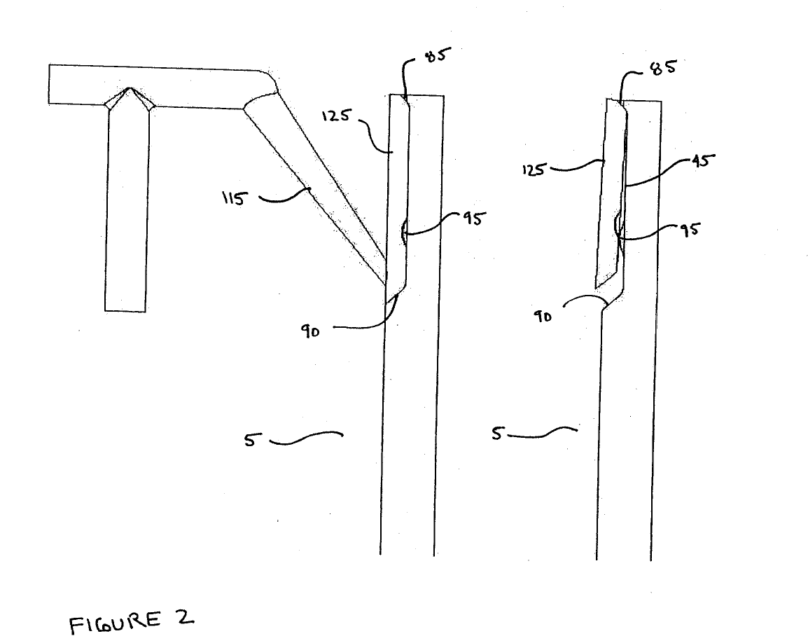

In another aspect of the invention, the geometry of the flow pin 5 is adapted to form a plastic tab 125 that is forced away from the geometry 40 when the plastic cools. With reference to FIG. 2, the gate 115 is shown intersecting the second radial portion 90 at an angle of approximately 45 degrees. Plastic mold material is shown conforming to the geometry 40 of the flow pin 5. When the plastic material is allowed to cool in a curing cycle of a mold operation, the plastic material shrinks in a linear fashion such that the tab 125 is forced away from the flow pin due to the linear contraction of the plastic material relative to the raised ridge 95 formed on the planar area 45. The separation of the plastic tab 125 is shown in FIG. 2 after the plastic material has been allowed to cool. The first and second radius portions 85, 90 serve to modify the flow characteristics of the molten plastic material, as well as to provide a weakened area on the plastic tab 125 such that the plastic snaps in the weakened area when a part is removed by an ejection cycle from the mold. Specifically, as the flow pin 5 is moved upward in an ejection cycle by the ejector plate 25, as seen in FIG. 3, the plastic material snaps in a region near the gate 115 due to the weakened area formed by the second radius portion 90. As the flow pin 5 continues further upon its ejection stroke, the weakened portion formed by plastic material in the vicinity of the first radius 85 snaps from the part in a reliable fashion such that secondary trimming operations are minimized or eliminated. Due to the relatively large mass of the plastic tab 125, as well as the specific geometry 40, sink portions are not formed on a part during the molding process. Again, due to the shrinkage of the plastic tab 125 during a curing process, the tab 125 cannot reenter the gate 115 area when the flow pin 5 is retracted back into its starting position at an end of the ejection cycle. This feature by concept eliminates the possibility of malfunction upon retraction of the flow pin 5.

In another aspect of the invention, there is detailed a method of forming a plastic part in an ejection mold, including the steps of providing an injection mold tool including a mold cavity that is shaped to form a part, providing a bore 120 in the injection mold tool that extends from an ejection plate 25 at a first end of the bore 120 to a gate 115 opening entering the cavity 35 at the second end, disposing a flow pin 5 within the bore 120 as previously described wherein the flow pin 5 has flow modifying geometry 40 formed on a second end 20 which is proximate a gate 115 opening that introduces plastic material into the mold cavity 35. Plastic material is introduced into the mold cavity 35 from a gate 115 proximate the second radius 90, as described above, such that the plastic material flowing over the geometry 40 of the flow pin 5 creates a mass of plastic material that is increased proximate the gate 115 opening. As discussed above, an injection pressure is reduced as the material flows against the first radius 85 while a flow rate of the plastic material in the mold is increased relative to typical injection molding processes due to the increased area provided by the flow pin 5. As stated above, the flow modifying geometry 40 creates a plastic tab 125 that is forced away from the geometry 40 as the plastic cools. As described above, the plastic tab 125 snaps at the gate 115 opening during an ejection of the part from the mold. The plastic tab 125 also snaps in a weakened region in the vicinity of the first radius 85 minimizing or eliminating the need for secondary trimming operations.

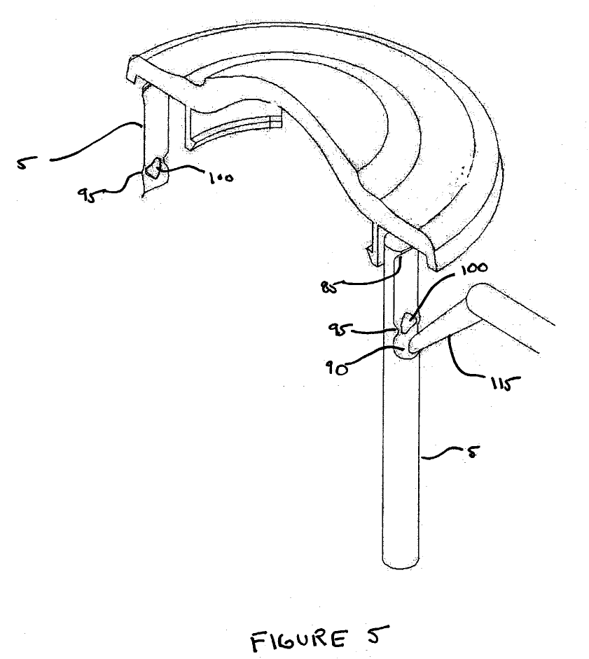

In an alternative aspect of the invention, two mold flow pins may be disposed within the mold and separated 180° apart from each other within the mold to create a cold slug pocket that minimizes a knit line of a part, as shown in FIG. 5. In this manner, the surface characteristics of a part can be improved while also increasing the relative strength of a part.

While the invention has been described in terms of certain preferred embodiments, it is apparent that other embodiments could readily be devised by one skilled in the art. The scope of the invention is to be considered limited only by the following claims.

1. An injection mold flow pin comprising:
a cylindrical element including first and second ends;
the first end attached to an ejector plate of an injection mold;
the second end disposed proximate a gate opening of a mold cavity, the second end including flow modifying geometry formed thereon;
the flow modifying geometry adapted to increase a mass of plastic material proximate the gate opening wherein an injection pressure is reduced and a flow rate of plastic material into the mold cavity is increased.

2. The injection mold flow pin of claim 1 wherein the flow modifying geometry comprises a planar area having a length along the centerline of the cylindrical element and a width along the diameter of the cylindrical element, the planar area comprising a cut away section of the cylindrical element, the planar area bounded on opposite ends of its length by first and second radius portions.

3. The injection mold flow pin of claim 2 wherein the planar area further includes a raised ridge formed across the width of the planar area.

4. The injection mold flow pin of claim 3 wherein the raised ridge further includes a channel extending through the raised ridge in a direction of the length of the planar area.

5. The injection mold flow pin of claim 4 wherein the channel has an elliptical cross section.

6. The injection mold flow pin of claim 2 wherein the first radius portion is proximate the second end of the cylindrical element.

7. The injection mold flow pin of claim 6 wherein the first radius portion terminates in a land portion, wherein a fill area of the mold is increased.

8. The injection mold flow pin of claim 7 wherein the land portion is minimized for enhancing plastic flow characteristics.

9. The injection mold flow pin of claim 7 wherein the land portion is convex.

10. The injection mold flow pin of claim 7 wherein the land portion is concave.

11. The injection mold flow pin of claim 7 wherein the land portion has a variable curvature increasing from one side of the land to the other side in a direction corresponding to the width of the planar area.

12. The injection mold flow pin of claim 7 wherein the land portion further includes a radial flow channel formed therein.

13. The injection mold flow pin of claim 2 wherein the second radius is proximate a gate directing plastic material to a cavity of the mold.

14. The injection mold flow pin of claim 13 wherein the gate intersects the second radius at an angle of from 20 to 50 degrees.

15. An injection mold flow pin comprising:
an injection mold including a bore formed therein, the bore terminating in a cavity side of the mold,
a cylindrical element disposed in the bore, the cylindrical element including a first end attached to an ejector plate of the mold and a second end disposed proximate a gate opening of the mold cavity, the second end including flow modifying geometry formed thereon;
the flow modifying geometry adapted to form a plastic tab that is forced away from the geometry when the plastic cools whereby the plastic tab snaps at the gate opening during an ejection of a part from the mold eliminating the need for secondary surface forming operations.

16. A method of forming a plastic part in an injection mold comprising the steps of:
providing an injection mold tool including a mold cavity shaped to form a part;
providing a bore in the injection mold tool extending from an ejection plate at a first end of the bore to a gate opening entering the cavity at the second end;
disposing a flow pin within the bore, the flow pin comprising a cylindrical element including a first end attached to the ejector plate of the mold and a second end disposed proximate a gate for introducing plastic material into the mold cavity, the second end including flow modifying geometry formed thereon;
introducing plastic material into the mold cavity from the gate, the plastic material flowing over the geometry of the flow pin wherein a mass of plastic material is increased proximate the gate opening wherein an injection pressure is reduced and a flow rate of plastic material into the mold cavity is increased.

17. The method of forming a plastic part in an injection mold of claim 16 wherein the flow modifying geometry is adapted to form a plastic tab that is forced away from the geometry when the plastic cools after being introduced into the mold and wherein the plastic tab snaps at the gate opening during an ejection of a part from the mold minimizing or eliminating the need for secondary trimming operations.

18. The method of forming a plastic part in an injection mold of claim 16 wherein two mold flow pins are disposed 180 degrees apart within the mold tool thereby creating a cold slug pocket for minimizing a knit line of a part.
